(19) United States
(12) Patent Application Publication
(10) Pub. No.: US 2008/0266665 A1
(43) Pub. Date: Oct. 30, 2008

(54) Lens system for traffic signal lighting

(76) Inventor: Jose Manuel Sasian-Alvarado, Tucson, AZ (US)

Correspondence Address: JACKSON WALKER LLP, 901 MAIN STREET, SUITE 6000, DALLAS, TX, 75202-3797, US

(21) Appl. No.: 11/789,777

(22) Filed: Apr. 25, 2007

(51) Int. Cl. G02B 3/08; G02B 5/02

(52) U.S. Cl. 359/599; 359/742

(57) ABSTRACT

A traffic light compound lens system is presented that utilizes two Fresnel lenses to provide a more efficient lens system with better light directing capabilities than a single lens system. The optical power of each Fresnel lens is less than that required for the single lens system. Due to aberration reduction, the compound lens system has less geometrical aberration than a single lens system, especially over a larger field of view, and has improved directionality. In addition, the compound lens system has better collection efficiency.

### FIELD OF THE INVENTION

The present invention is generally related to traffic signaling, and more specifically to a lens system adapted to direct light from an array of light emitting diodes (LEDs) in a traffic signal.

### BACKGROUND OF THE INVENTION

In modem traffic signals it is desirable to signal different traffic lanes and therefore traffic signals are required to independently send out signal light. In addition for power efficiency and cost reduction the new bright LEDs are being used. To make efficient use of the light from an LED array it is necessary to use a lens, typically a Fresnel lens, so that light can be collimated and sent to the street as shown in FIG. 1. The Fresnel lens collimates, or nearly so, the light from the LEDs. In order to have a fully illuminated signal as seen by a viewer, a scattering surface is often added to the rear surface of the Fresnel lens.

However this lens system is not the most efficient system and for large off axis viewing distances it appears partially illuminated with a bow-tie type of pattern when the traffic signal is on.

### SUMMARY OF INVENTION

The present invention achieves technical advantages as a traffic light compound lens system. One embodiment of the invention utilizes two Fresnel lenses to provide a more efficient lens system with better light directing capabilities than a single lens system. Advantageously, the optical power of each Fresnel lens is less than that required for the single lens system. Due to aberration reduction, the compound lens system has less geometrical aberration than a single lens system, especially over a larger field of view.

### BRIEF DESCRIPTION OF THE DRAWINGS

FIG. 1 is a diagram of a traditional traffic light single lens system; and

FIG. 2 is a diagram of a traffic light compound lens system in accordance with an exemplary embodiment of the present invention.

### DETAILED DESCRIPTION OF THE PRESENT INVENTION

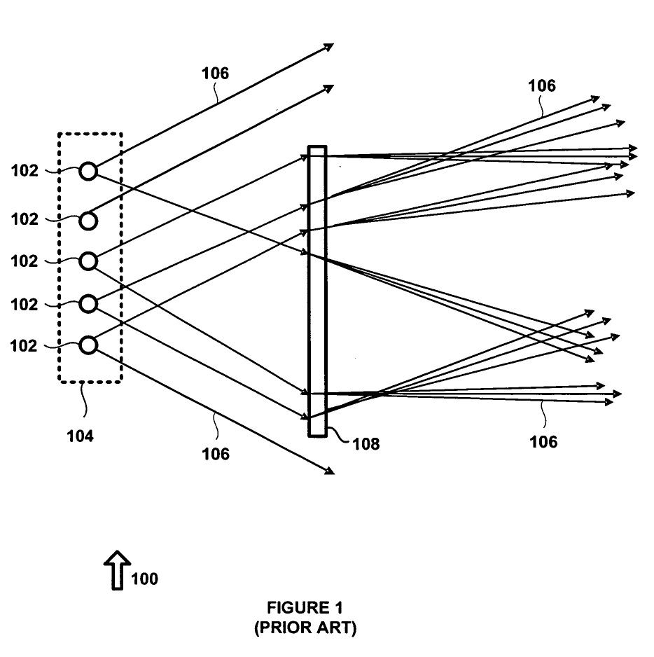

Referring to FIG. 1, there is shown at 100 a traditional traffic light single lens system. A light source, such as LED array 104 with a plurality of LEDs 102, generates light 106 for use in traffic signals. Light 106 propagates through Fresnel lens 108, which provides a large aperture and a short focal length, and continues to a viewer. The purpose of LED array 104 and Fresnel lens 108 is to selectively direct light 106 to groups of lanes on the street. Some of light 106 is wasted, as shown by light 106 missing Fresnel lens 108, and leads to a dim or partially illuminated signal to the viewer.

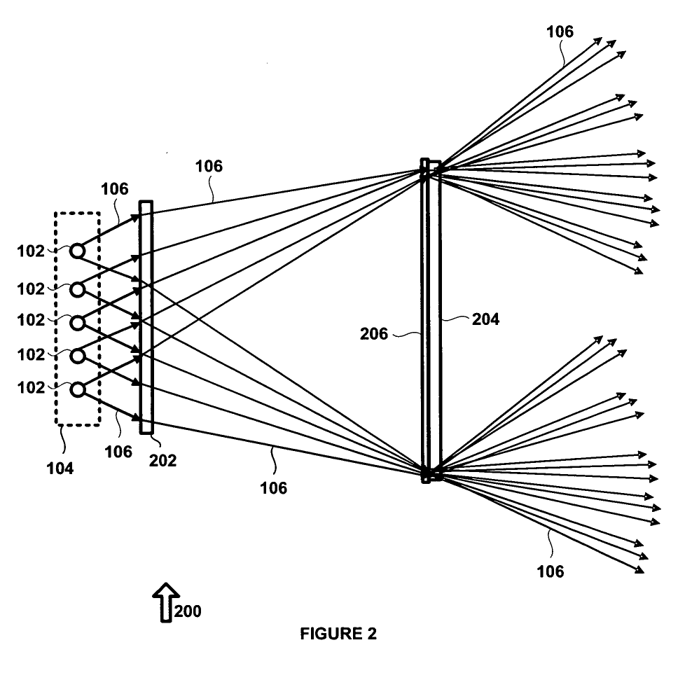

Referring now to FIG. 2, there is shown at 200 a traffic light compound lens system in accordance with an exemplary embodiment of the present invention. The compound lens system 200, consists of LED array 104, first Fresnel lens 202, and second Fresnel lens 204. First Fresnel lens 202 is closest to LED array 104 and second Fresnel lens 204 is furthest from LED array 104. Second Fresnel lens 204 is positioned by a distance of approximately the focal length of first Fresnel lens 202 from first Fresnel lens 202. The compound lens system 200 provides a more efficient lens system with better light directing capabilities than the single Fresnel lens system 100. By using first Fresnel lens 202 and second Fresnel lens 204, light 106 from LED array 104 is substantially conserved and more accurately directed toward an area.

Advantageously, the optical power of each Fresnel lens 202 and 204 is less than that required for a single lens system 100. Additionally, because of aberration reduction the compound lens system 200 mitigates geometrical aberration better than a single lens system, especially over a larger field of view. Moreover, first Fresnel lens 202 can act as a collector and direct light toward second Fresnel lens 204 so that a miniscule amount of light from the LED array 104 is wasted. This is especially true for off-axis LEDs. Both Fresnel lenses 202 and 204 have a positive focal length. The focal length of first and second Fresnel lenses, 202 and 204 respectively, are in the range of ratios 1/3 to 3. In one exemplary embodiment, first Fresnel lens 202 has a focal length of approximately 8 inches and second Fresnel lens 204 has a focal length of approximately 12 inches. The compound lens system 200 is nearly telecentric in the LED space.

To improve the light filling, or how it appears illuminated from the viewer's standpoint, light scattering or diffusing surface 206 can be added to the compound lens system 200. In one exemplary embodiment, light scattering or diffusing surface 206 is operably positioned in a plane between LED array 104 and first Fresnel lens 202 to improve light distribution. In a second exemplary embodiment, light scattering or diffusing surface 206 is operably coupled to the first Fresnel lens 202. In a third exemplary embodiment, light scattering or diffusing surface 206 is operably positioned in a plane between first Fresnel lens 202 and second Fresnel lens 204. In a fourth exemplary embodiment, light scattering or diffusing surface 206 is operably coupled to the second Fresnel lens 204. In a fifth exemplary embodiment, light scattering or diffusing surface 206 is operably coupled to the LED array 104.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A traffic light compound lens system, comprising:
a light source adapted to generate light for use in a traffic light;
a first Fresnel lens adapted to propagate the light therethrough; and
a second Fresnel lens, spaced by a distance of approximately the focal length of the first Fresnel lens from the first Fresnel lens, adapted to direct the light to an area.

2. The traffic light compound lens system of claim 1, further comprising a light scattering or diffusing surface to improve distribution of the light.

3. The light scattering or diffusing surface of claim 2, wherein the light scattering or diffusing surface is operably positioned in a plane between the light source and the first Fresnel lens.

4. The light scattering or diffusing surface of claim 2, wherein the light scattering or diffusing surface is operably coupled to the first Fresnel lens.

5. The light scattering or diffusing surface of claim 2, wherein the light scattering or diffusing surface is operably positioned in a plane between the first Fresnel lens and the second Fresnel lens.

6. The light scattering or diffusing surface of claim 2, wherein the light scattering or diffusing surface is operably coupled to the second Fresnel lens.

7. The light scattering or diffusing surface of claim 2, wherein the light scattering or diffusing surface is operably coupled to the light source.

8. The traffic light compound lens system of claim 1, wherein an optical conjugate distance of the second Fresnel lens is optimized for an infinite image distance.

9. The traffic light compound lens system of claim 1, wherein the Fresnel lens aperture is in the range of 4 to 20 inches in diameter and the diameter of the first Fresnel lens aperture is equal or smaller than the diameter of the second Fresnel lens aperture.

10. The traffic light compound lens system of claim 1, wherein the focal length of the first and the second Fresnel lenses are in the range of ratios 1/3 to 3.

11. The traffic light compound lens system of claim 1, wherein the first and the second Fresnel lenses have the same focal length.

12. The traffic light compound lens system of claim 1, wherein the combination of the first and the second Fresnel lens mitigates geometrical aberration and both lenses make a more efficient light collection.

13. The traffic light compound lens system of claim 1, wherein the optical conjugate distances for the first Fresnel lens are approximately 1) the distance to the focal point of the second Fresnel lens and 2) the distance to the light source measured from the first Fresnel lens. And wherein the optical conjugate distances for the second lens are approximately 1) infinity and 2) its own focal distance.

14. A non-imaging optical system, comprising:
a light source adapted to generate light for use in a traffic light;
a first Fresnel lens adapted to propagate the light therethrough; and
a second Fresnel lens, spaced by a distance of approximately the focal length of the first Fresnel lens from the first Fresnel lens, adapted to project the light toward a distant object.

15. The non-imaging optical system of claim 14, further comprising a light scattering or diffusing surface to improve distribution of the light.

16. The light scattering or diffusing surface of claim 15, wherein the light scattering or diffusing surface is operably positioned in a plane between the light source and the first Fresnel lens.

17. The light scattering or diffusing surface of claim 15, wherein the light scattering or diffusing surface is operably coupled to the first Fresnel lens.

18. The light scattering or diffusing surface of claim 15, wherein the light scattering or diffusing surface is operably positioned in a plane between the first Fresnel lens and the second Fresnel lens.

19. The light scattering or diffusing surface of claim 15, wherein the light scattering or diffusing surface is operably coupled to the second Fresnel lens.

20. The light scattering or diffusing surface of claim 15, wherein the light scattering or diffusing surface is operably coupled to the light source.
